(19) United States
(12) Patent Application Publication
(10) Pub. No.: US 2023/0136652 A1
(43) Pub. Date: May 4, 2023

(54) Self-check Brake Lights Apparatus

(71) Applicant: Cedrick Malone, Memphis, TN (US)

(72) Inventor: Cedrick Malone, Memphis, TN (US)

(21) Appl. No.: 17/586,933

(22) Filed: Jan. 28, 2022

Related U.S. Application Data
(60) Provisional application No. 63/273,273, filed on Oct. 29, 2021.

(51) Int. Cl. B60T 17/22

(52) U.S. Cl. CPC B60T 17/223

(57) ABSTRACT

The present invention relates to a novel self-check brake light apparatus for a vehicle. The apparatus includes a telescoping handle having two telescoping members for extending or retracting a length of the apparatus. The telescoping handles have pins that are used for releasably locking the members using a pin. A C-shaped hook is positioned at one end and is configured to attach to a brake pedal of the vehicle for depressing the brake pedal while a cushion member at the opposite end is configured to rest against a frontside of the driver's seat base to keep the apparatus in place, such that the brake pedal is depressed and the brake lights are actuated. The operator can then move to the rear of the vehicle to check the operation of the brake lights independently without requiring assistance from another.

### CROSS-REFERENCE TO RELATED APPLICATION

The present application claims priority to, and the benefit of, U.S. Provisional Application No. 63/273,273, which was filed on Oct. 29, 2021 and is incorporated herein by reference in its entirety.

### FIELD OF THE INVENTION

The present invention relates generally to the field of detecting functionality of brake lights of a vehicle as well as to an apparatus suitable for actuating brake lights of the vehicle. More specifically, the present invention relates to a novel apparatus that allows drivers to check the functionality of brake lights of their vehicle independently and individually prior to operating the vehicle. The apparatus features an extendable structure in which a C-shaped hook depresses the brake pedal while a cushion at the opposite end rests against the driver's seat base to keep the apparatus in place, such that the brake pedal is depressed and the brake lights are actuated. This allows a driver to go to the rear of the vehicle to check functionality of the brake lights independently which obviates the need to push the brake pedal by foot and enlist the assistance of another. Accordingly, the present disclosure makes specific reference thereto. Nonetheless, it is to be appreciated that aspects of the present invention are also equally applicable to other like applications, devices and methods of manufacture.

### BACKGROUND

By way of background, vehicles such as automobiles have brake lights. Typically, vehicles have a brake light proximal to each rear corner of the vehicle and a centrally mounted brake light positioned above (i.e. higher than) the corner lights. When a driver brakes to slow a vehicle, the brake lights are illuminated. The brake lights are mounted on the rear of the vehicle, so the driver of a following vehicle can be informed that the vehicle is slowing down or has stopped as indicated by the illuminated brake lights. The brake lights are an essential safety feature and it is critical to have working brake lights for alerting motorists traveling behind. Working brake lights are also critical to ensure compliance with vehicle legal codes or statutes.

Dysfunctional brake lights are not only dangerous for the vehicle but also for passengers of other vehicles. People may also get an expensive ticket when pulled over by law enforcement for broken, dysfunctional or burned-out brake lights and/or bulbs.

Generally, brake lights are checked by people before starting a journey. For checking brake lights, at least two individuals are required. One person stands behind the vehicle to check the brake light whereas the other person steps on or pushes the brake pedal. It is nearly impossible for a single person to independently examine and check the brake lights. The single person can just roughly assume, while pushing the brake pedal, if the brake light is in working status or not.

Therefore, there exists a long felt need in the art for brake light checking device that enables a single person to independently check the status of the brake lights of a vehicle. There is also a long felt need in the art for a device that provides an easy way to let vehicle owners and auto mechanics know about the status of the brake lights. Additionally, there is a long felt need in the art for a brake light status check device that prevents users from driving a vehicle having dysfunctional brake lights. Moreover, there is a long felt need in the art for a device that prevents people from being issued expensive tickets for dysfunctional or broken brake lights. Further, there is a long felt need in the art for a device that can be stored in the vehicle and can be used anywhere by a vehicle owner or auto mechanic. Furthermore, there is a long felt need in the art of a brake light checking apparatus that is easy to use. Finally, there is a long felt need in the art for a brake light checking apparatus that offers a way for a single individual to ensure that brake lights are working, thereby prohibiting law enforcement from issuing tickets.

The subject matter disclosed and claimed herein, in one embodiment thereof, comprises a brake light actuating device for a vehicle. The device features an adjustable and stick-like extendable or telescoping member, a hook for applying depressing to the brake pedal, a non-slipping soft cushion for placing against the underside or frontside of the driver's seat wherein the device applies the pressure on the brake pedal surface to actuate the brake lights without requiring a user to push the brake pedal using a foot. By placing the hook of the device on the brake pedal and the other end to the underside of the driver's seat, the operator/owner can go to the rear of the vehicle to check the operation and proper functioning of the brake lights independently.

In this manner, the self-check brake light apparatus of the present invention accomplishes all of the forgoing objectives and provides users with a multipurpose, lightweight, portable and easy to use device that enables drivers to independently check their brake lights for functionality prior to operating the vehicle. The device pushes the brake pedal downward and maintains the depressed pedal while the driver can go to rear of the vehicle to check the status of the brake lights. Further, the device can be folded or retracted, and stored in the backseat of the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-check brake light apparatus. The apparatus is designed to enable a driver to independently check the brake lights of their vehicle for functionality prior to operating the vehicle while obviating the need to enlist the help of any other person. The apparatus further comprising an extendable handle including a bottom telescoping member and a top telescoping member; the bottom telescoping member is configured to slidably dispose inside the top telescoping member; a C-shaped hook disposed at one end of the bottom telescoping member; a cushion disposed at one end of the top telescoping member; both the telescoping members have corresponding pin holes wherein a pin is inserted into a pair of aligned holes (matingly alignable) to releasably lock the telescoping members; the C-shaped hook is configured to attach to the brake pedal of a vehicle; and, the cushion is configured to position on the underside of a driver's seat of the vehicle. The apparatus applies force on the brake surface of the brake pedal to actuate the brake lights when both the C-shaped hook is attached to the brake pedal and the cushion is positioned on the underside (or frontside) of the driver's seat.

In yet another embodiment, the apparatus obviates a driver from pushing the brake pedal with the foot for actuating the brake lights.

In yet another embodiment, the telescoping members can be locked at various lengths for providing a determinable length of the handle in the range between two feet and five feet.

In yet another embodiment, the apparatus is made from lightweight metal, alloy or heavy-duty plastic.

In yet another embodiment, the pin can be re-inserted into different holes to adjust the determinable length of the handle.

In yet another embodiment, the brake light actuating device for a vehicle is disclosed. The device is comprised of an adjustable and stick-like extendable member, a hook for applying pressure on the brake pedal, a non-slipping soft cushion for placing against the underside of the driver's seat wherein the device applies the pressure on the brake pedal surface to actuate the brake lights without requiring a user to push the brake pedal using a foot. The user can go to the rear of the vehicle to check the functionality of the brake lights while the brake pedal is being depressed by the device.

In yet another embodiment, the cushion member is replaceable and is non-slipping and does not cause scratches to the driver's seat.

In yet another embodiment, the stick-like extendable member includes a bottom telescoping stick and a top telescoping stick wherein the top telescoping stick is broader (i.e. larger diameter or cross section) than the bottom telescoping stick.

In yet another embodiment, a method for independently checking the functionality of brake lights of a vehicle by a driver without enlisting help of any other individual is described. The method includes the steps of: providing a brake light checking device, the device includes an extendable handle, a hook and a cushion; placing the hook on the brake pedal such that the handle extends from the pedal surface; setting a length of the handle such that the cushion can be positioned on the underside or frontside of the driver's seat wherein the hook pushes the brake pedal to actuate the brake lights; and, reviewing the functionality of the brake lights by the driver through viewing the rear of the vehicle before operating the vehicle.

In yet another embodiment, the method prevents issuance of expensive tickets due to operating non-functional or broken brake lights while driving in violation of legal codes or statutes.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a self-check brake light apparatus of the present invention in accordance with the disclosed architecture;

FIG. 2 illustrates a perspective view showing how the C-shaped hook of the brake light checking apparatus is attached to the brake pedal of a vehicle in accordance with the disclosed architecture;

FIG. 3 illustrates a perspective view showing the brake light checking apparatus placed between the brake pedal and the driver's seat while depressing the brake pedal in accordance with the disclosed architecture;

FIG. 4 illustrates a perspective view showing actuated brake lights when the brake pedal is depressed by the brake lights checking device of the present invention in accordance with the disclosed architecture; and

FIG. 5 illustrates a flow diagram showing exemplary steps performed by a user for installing the self-check brake light apparatus and reviewing the brake lights in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a brake light checking device that enables a single person to independently check the status of the brake lights of a vehicle. There is also a long felt need in the art for a device that provides an easy way to let vehicle owners know about the status of their brake lights. Additionally, there is a long felt need in the art for a brake light status check device that prevents users from driving a vehicle having dysfunctional brake lights. Moreover, there is a long felt need in the art for a device that prevents people from being issued expensive tickets for dysfunctional or broken brake lights in violation of vehicle codes or statutes. Further, there is a long felt need in the art for a device that can be stored in the vehicle and can be used anywhere by a vehicle owner or auto mechanic. Furthermore, there is a long felt need in the art of a brake light checking apparatus that is easy to use. Finally, there is a long felt need in the art for a brake light checking apparatus that offers a way for a single individual to ensure that brake lights are working, thereby preventing law enforcement from issuing tickets for vehicle code and statute violations.

The present invention, in one exemplary embodiment, is a novel method for independently checking the functionality of brake lights of a vehicle by a driver without enlisting the assistance of any other individual. The method includes the steps of: providing a brake light checking device, the device includes an extendable handle, a hook and a cushion; placing the hook on the brake pedal such that the handle extends from the brake pedal surface; setting a predetermined length of the handle such that the cushion can be positioned on the underside or frontside of the driver's seat wherein the hook pushes the brake pedal to actuate the brake lights; and, reviewing functionality of the brake lights by the driver by viewing the rear of the vehicle before operating the vehicle.

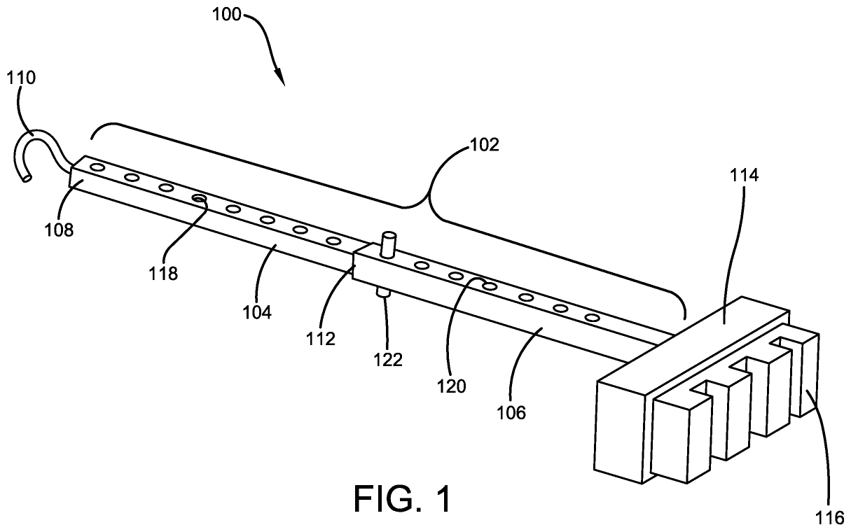

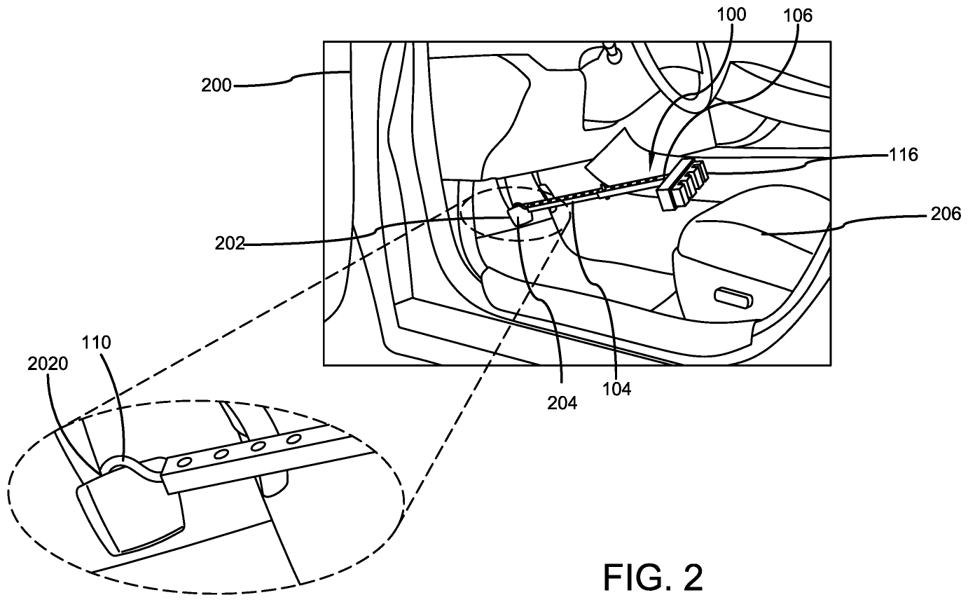

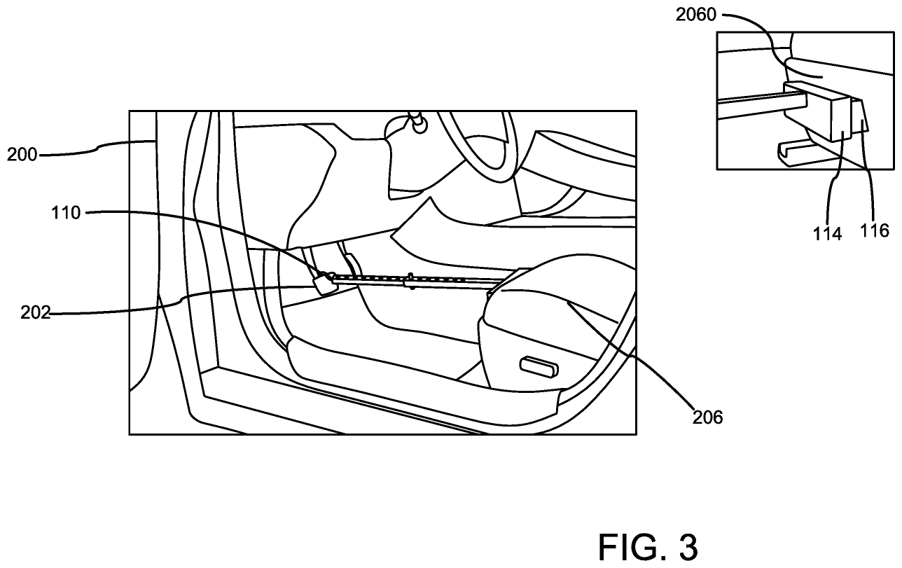

Referring initially to the drawings, FIG. 1 illustrates a perspective view of one potential embodiment of a self-check brake light apparatus 100 of the present invention in accordance with the disclosed architecture. The self-check brake light apparatus 100 of the present invention enables the drivers to check the brake lights of their vehicles independently and individually before operating the vehicle. The apparatus 100 is installed inside a vehicle between the brake pedal and the driver's seat to actuate the brake lights. More specifically, the apparatus 100 includes a telescoping elongated handle 102 including a bottom telescoping stick section 104 and a top telescoping stick section 106. The bottom telescoping stick section 104 includes a first end 108 having a C-shaped hook 110. The C-shaped hook 110 can be placed onto a top edge of the brake pedal of the vehicle as best shown in FIG. 2. The top telescoping stick section 106 is wider (i.e. larger diameter, cross section, or dimensions) than the bottom telescoping stick section 104 and is configured to receive a portion of the bottom telescoping stick section 104. The top telescoping stick section 106 includes an open end 112 through which the bottom telescoping stick section 104 is partially inserted into the top telescoping stick section 106 and includes an opposite closed end 114 that includes a rectangular and slip resistant cushion 116. In use, the cushion 116 rests against a frontside of the driver's seat of the vehicle as best shown in FIG. 3.

The bottom telescoping stick section 104 includes a set of telescoping pin holes 118 and the top telescoping stick section 106 includes a corresponding set of telescoping pin holes 120. The telescoping pin holes 118,120 of the sticks 104,106 respectively are aligned (i.e. matingly alignable) with each other such that a retention pin 122 can be inserted into a pair of aligned pin holes of the sticks or sections 104,106 to lock the telescoping elongated handle 102 at a desired length. The retention pin 122 releasably locks the bottom telescoping member or section 104 and the top telescoping member or section 106 in an extended position. The telescoping nature of the apparatus 100 enables the apparatus 100 to be adjusted to various lengths and thus can be used for a variety of vehicles that have different distances between the brake pedal and the driver's seat. More precisely, the bottom telescoping tube or section 104 fits in and moves within the top telescoping tube or section 106.

It should be noted that the when the device 100 is not used, the device 100 can be retracted to a compact length by inserting the maximum portion of the bottom telescoping stick section 104 into the top telescoping stick section 106. This is helpful for compact and easy storage of the device 100 in a trunk or backseat of the vehicle when the device 100 is not in use.

The apparatus 100 can be made from lightweight and sturdy metal, heavy duty plastic, alloy, or any other similar material. Further, the length of the telescoping elongated handle 102 can be in the range from about 2 feet to about 5 feet, for example.

FIG. 2 illustrates a perspective view showing how the C-shaped hook 110 of the brake lights checking apparatus 100 attached to the brake pedal of a vehicle in accordance with the disclosed architecture. The apparatus 100 is used for actuating the brake lights of the vehicle 200 such that a user is not required to push the brake pedal and obviates the need for the user to be inside the vehicle 200 while checking the brake lights. For actuating the brake lights, the C-shaped hook 110 is attached to the brake pedal 202 of the vehicle. An edge 2020 of the pedal 202 is locked into the hook 110 such that the pedal 202 can be depressed by the device 100 in a manner similar to the pedal 202 being depressed by a foot of a user. The bottom telescoping member 104 extends from the pedal surface 204 such that the pedal 202 can be easily depressed when force is applied on the pedal surface 204.

It should be noted that the length of the handle 102 can be locked before attaching the C-shaped hook 110 to the pedal 202 or can be locked after attaching the C-shaped hook 110 to the pedal 202. The device 100 can be handled easily after hooking the C-shaped hook 110 to the pedal 202 for placing the cushion 116 against the driver's seat 206 as best shown in FIG. 3.

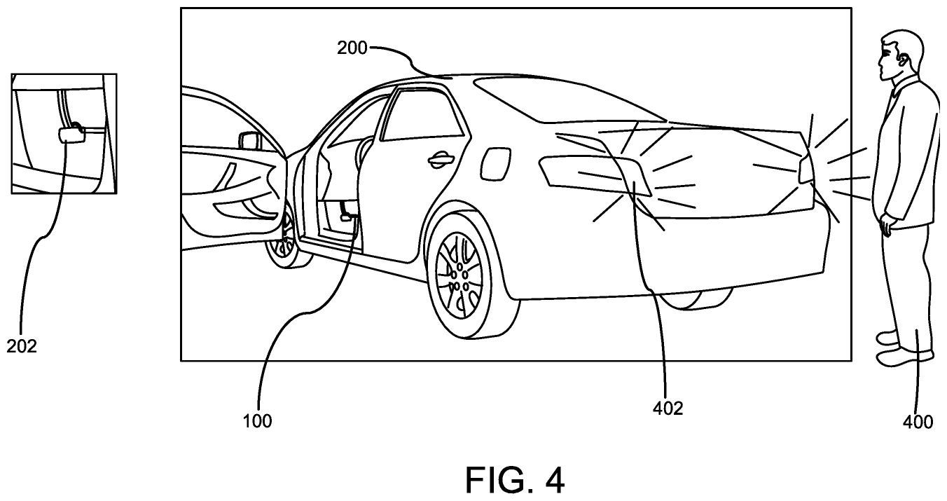

FIG. 3 illustrates a perspective view showing the brake light checking apparatus 100 placed between the brake pedal 202 and the driver's seat 206, while depressing the brake pedal 202 in accordance with the disclosed architecture. The apparatus 100, when attached to the brake pedal 202 as shown in FIG. 2, initially does not press or push the pedal 202 to actuate the brake lights. For pushing the pedal 202, the cushion 116 disposed at the closed end 114 of the device 100 is positioned on the frontside 2060 of the driver's seat 206 while the C-shaped hook 110 is attached to the pedal 202. The device 100 in this configuration applies force on the pedal surface 204 such that the pedal 202 is pushed or depressed in a similar manner as being depressed by the foot of a user. The functioning of the apparatus 100 on the brake pedal 202 is similar to being depressed by the foot of a user. When the brake pedal 202 is depressed, the brake lights are actuated as shown in FIG. 4 and can be reviewed by the operator by moving to the rear of the vehicle 200 and viewing same.

It should be appreciated that the device 100 obviates the requirement for a user to be inside the vehicle 200 and pushing the brake pedal 202 by foot actuation. The device 100 once installed as described can depress the brake pedal 202 and actuate the brake lights. The user, therefore, can independently and individually check and observe the functionality of the brake lights.

The cushion 116 is soft and does not slip from the driver's seat 206. Further, the cushion 116 does not cause any damage to the driver's seat. The device 100 is removed by first removing the cushion 116 from the driver's seat 206 and then the C-shaped hook 110 is removed from the brake pedal 202.

FIG. 4 illustrates a perspective view showing actuated brake lights when the brake pedal 202 is depressed by the brake light checking device 100 of the present invention in accordance with the disclosed architecture. As shown, a driver or operator 400 of the vehicle 200 is standing at the rear of the vehicle 200 to view the illuminated brake lights 402 with the apparatus 100 installed in the vehicle 200 between the brake pedal 202 and the frontside 2060 of the driver's seat 206 as described in FIG. 3. The driver 400 does not need to be inside the vehicle 200 for depressing the brake pedal 202 to illuminate or actuate the brake lights 402. Once the brake lights 402 are reviewed by the driver 400, the device 100 can be removed and stored in the trunk or backseat of the vehicle 200.

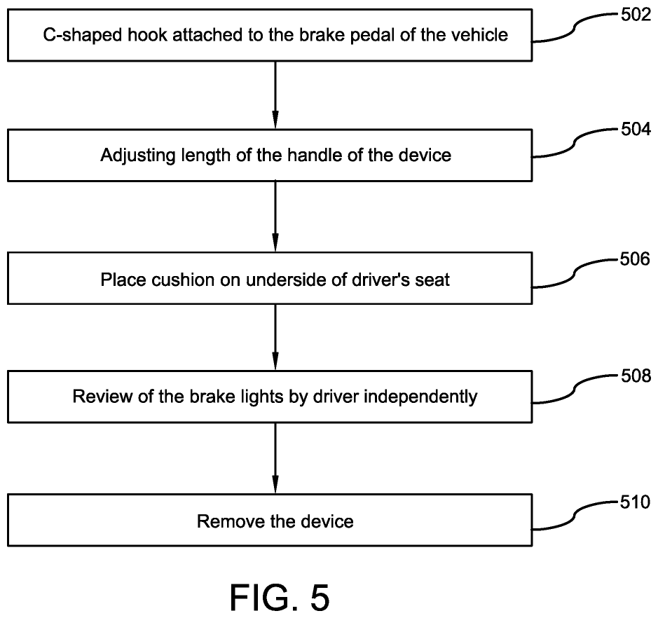

FIG. 5 illustrates a flow diagram showing exemplary steps performed by a user for installing the self-check brake light apparatus and reviewing the brake lights in accordance with the disclosed architecture. As shown, initially, the C-shaped hook of the device is attached to the brake pedal of the vehicle such that the handle extends away from the pedal surface (Step 502). Then, the length of the handle is fixed using the telescoping sticks, members or sections such that the device can be installed between the brake pedal and the driver's seat (Step 504). It should be noted that the order of execution of the above steps can be interchanged as per the desire of the user. Thereafter, the cushion of the device is fixed to the frontside of the driver's seat such that the device depresses the brake pedal to actuate brake lights (Step 506). Then, the driver/user reviews the brake lights by going to the rear of the vehicle while the device maintains the brake pedal in the depressed position (Step 508). Finally, the device is removed from the installed position and stored in the trunk or backseat of the vehicle (Step 510).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-check brake light apparatus”, “brake lights checking device”, “brake lights checking apparatus”, “brake lights actuating device”, “apparatus”, and “device” are interchangeable and refer to the self-check brake light apparatus 100 of the present invention.

Notwithstanding the forgoing, the self-check brake light apparatus 100 of the present invention can be of any suitable size and configuration as is known in the art without affecting the overall concept of the invention, provided that it accomplishes the above-stated objectives. One of ordinary skill in the art will appreciate that the size, configuration and material of the self-check brake light apparatus 100 as shown in the FIGS. are for illustrative purposes only, and that many other sizes and shapes of the self-check brake light apparatus 100 are well within the scope of the present disclosure. Although the dimensions of the self-check brake light apparatus 100 are important design parameters for user convenience, the self-check brake light apparatus 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An apparatus for self-checking actuation of vehicle brake lights, the apparatus comprising:
an elongated handle extending between a vehicle brake pedal and a vehicle's driver seat, wherein said elongated handle comprises a bottom section and a top section;
said bottom section telescopes within said top section;
said bottom section includes a plurality of pin holes, and said top section includes a plurality of pin holes;
the plurality of pin holes of the bottom section pin holes being matingly alignable with the plurality of pin holes of the top section for selective securement of a retention pin therein, wherein said selective securement of said retention pin retains said elongated handle at a predetermined length;
said bottom section comprises a C-shaped hook at a first terminal end for securement to the vehicle brake pedal; and
said top section comprises a slip resistant cushion at a second terminal end for resting against a frontside of the vehicle's driver seat, wherein said predetermined length includes a length for depressing the vehicle brake pedal to actuate the vehicle brake lights.

2. The apparatus of claim 1, wherein said C-shaped hook is secured to a top edge of the vehicle brake pedal.

3. The apparatus of claim 2, wherein said top section includes a cross section and said bottom section includes a cross section, and further wherein said top section cross section is larger than said bottom section cross section.

4. The apparatus of claim 3, wherein said slip resistant cushion is rectangular.

5. The apparatus of claim 4, wherein a majority of said bottom section is retractable within said top section.

6. The apparatus of claim 5, wherein said handle is comprised of a material selected from a group consisting of a metal, a plastic and an alloy.

7. The apparatus of claim 5, wherein said predetermined length is selectively extendable from about two feet to about five feet.

8. An apparatus for self-checking actuation of vehicle brake lights, the apparatus comprising:
an elongated handle extending between a vehicle brake pedal and a vehicle's driver seat, wherein said elongated handle comprises a bottom section and a top section;
said bottom section having a plurality of pin holes and said top section having a plurality of pin holes;
said plurality of pin holes of the bottom section being matingly alignable with said plurality of pin holes of the top section for selective securement of a retention pin therein, wherein said selective securement of said retention pin retains said elongated handle at a predetermined length;
said bottom section comprising a hook at a first terminal end for securement to the vehicle brake pedal; and
said top section comprising a slip resistant cushion at a second terminal end for resting against a frontside of the vehicle's driver seat, wherein said predetermined length includes a length for depressing the vehicle brake pedal to actuate the vehicle brake lights, and further wherein said predetermined length maintains the depressing of the vehicle brake pedal to allow checking of the actuation of the vehicle brake lights.

9. The apparatus of claim 8, wherein said hook is a C-shaped hook secured to a top edge of the vehicle brake pedal.

10. The apparatus of claim 8, wherein said top section includes a cross section and said bottom section includes a cross section, wherein said top section cross section is larger than said bottom section cross section, and further wherein said bottom section and said top section are telescoping.

11. The apparatus of claim 10, wherein said slip resistant cushion is rectangular.

12. The apparatus of claim 10, wherein a majority of said bottom section is retractable within said top section.

13. The apparatus of claim 10, wherein said handle is comprised of a material selected from a group consisting of a metal, a plastic and an alloy.

14. The apparatus of claim 10, wherein said predetermined length is selectively extendable from about two feet to about five feet.

15. A method for independently checking a vehicle's brake lights, the method comprising the steps of:
extending an elongated handle between a vehicle brake pedal and a vehicle's driver seat, wherein said elongated handle comprises a bottom section having a plurality of pin holes and a top section having a plurality of pin holes;
aligning said plurality of pin holes of the bottom section pin holes with said plurality of pin holes of the top section;
selectively securing a retention pin through a select one of the plurality of pin holes in both of the top section and the bottom section, wherein said selective securement of said retention pin retains said elongated handle at a predetermined length;
securing a hook at a first terminal end of said bottom section to the vehicle brake pedal;
resting a slip resistant cushion at a second terminal end of said top section against a frontside of the vehicle's driver seat, wherein said predetermined length includes a length for depressing the vehicle brake pedal to actuate the vehicle brake lights;
maintaining the depressing of the vehicle brake pedal; and
checking the rear of the vehicle to verify actuation of the vehicle brake lights.

16. The method of claim 15, wherein said hook is a C-shaped hook secured to a top edge of the vehicle brake pedal.

17. The method of claim 15, wherein said top section includes a cross section and said bottom section includes a cross section, wherein said top section cross section is larger than said bottom section cross section, and further wherein said bottom section and said top section are telescoping.

18. The method of claim 15, wherein said slip resistant cushion is rectangular.

19. The method of claim 17, wherein a majority of said bottom section is retractable within said top section.

20. The method of claim 15, wherein said predetermined length is selectively extendable from about two feet to about five feet.
